(19) United States
(12) Patent Application Publication
(10) Pub. No.: US 2024/0401272 A1
(43) Pub. Date: Dec. 5, 2024

(54) TOOLS COMPRISING REPEATING STRUCTURES FORMED USING ADDITIVE MANUFACTURING PROCESSES

(71) Applicant: Hewlett-Packard Development Company, L.P., Spring, TX (US)

(72) Inventors: Mary Louise Gray BAKER, Palo Alto, CA (US); Nathan Eric SHIRLEY, Vancouver, WA (US); Ronnie George Parsons, Portland, OR (US); Matthew A. SHEPHERD, Vancouver, WA (US)

(21) Appl. No.: 18/700,244

(22) PCT Filed: Oct. 14, 2021
(86) PCT No.: PCT/US2021/071878

§ 371 Date: Apr. 10, 2024

(51) Int. Cl. D21F 1/66; B29C 64/386; B33Y 50/00; B33Y 80/00; D21J 3/00

(52) U.S. Cl. CPC D21F 1/66; B29C 64/386; D21J 3/00; B33Y 50/00; B33Y 80/00

(57) ABSTRACT

In some examples, a tool for manufacturing parts includes a body formed using an additive manufacturing process, where the body includes a plurality of repeating structures, and where the plurality of repeating structures include a first subset of repeating structures each having a first physical property as specified by a digital representation of the tool used in the additive manufacturing process, and a second subset of repeating structures each having a different second physical property as specified by the digital representation of the tool used in the additive manufacturing process.

### BACKGROUND

Molded fiber manufacturing uses molded fiber (also referred to as a molded pulp) to manufacture products. The molded fiber can include cellulose fibers, which can be made from recycled paper, cardboard, and so forth. Examples of products that can be manufactured using molded fiber manufacturing include trays, plates, containers, or other products.

A molded fiber manufacturing process uses a fibrous slurry including cellulose fibers suspended in a liquid, such as water. Mold tools are immersed in a tank filled with the fibrous slurry. The mold tools include a form and a screen. The form supports the screen, which defines a target shape of a product to be manufactured by the molded fiber manufacturing process.

A suction device can draw the fibrous slurry onto a surface of the screen, which has small pores. The liquid in the fibrous slurry is drawn through the pores of the screen, and the liquid exits through pores in the form to a plenum. The remaining portion of the fibrous slurry is a part that takes the shape of the form. In some molded fiber manufacturing processes, a transfer tool (another mold tool) can then be used to transfer the part away from the screen, and the transfer tool can move the part to another location for drying, such as in an oven or another location where heat can be applied to the part, or the part can be air dried.

The form, screen, and transfer tool are examples of mold tools that are used as part of a molded fiber manufacturing process. In other examples, molded fiber manufacturing processes can employ different techniques and mold tools.

### BRIEF DESCRIPTION OF THE DRAWINGS

Some implementations of the present disclosure are described with respect to the following figures:

FIG. 1A is a block diagram of a tool including repeating structures formed using an additive manufacturing process, according to some examples;

FIG. 1B is a perspective view of a screen including pores of different sizes, according to some examples.

FIG. 2 is a cross-sectional view of a screen with pores of different properties and pillars of different sizes, where the screen is mounted on a form, in accordance with some examples;

FIG. 3 is a flow diagram of a process according to some examples; and

FIGS. 4A-4B illustrate a screen with pores formed according to some examples.

FIG. 5 is a schematic diagram illustrating the determination of a size of a pore based on an orientation of the pore, according to some examples; and

FIG. 6 is a block diagram of the storage medium storing machine-readable instructions, according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Pores (openings) are examples of repeating structures that can be formed in mold tools used in molded fiber manufacturing processes. A pore is an opening in a tool, such as an opening to allow a flow of a liquid through the opening. Other types of repeating structures can also be formed in the mold tools, including pillars, dimples, protrusions, and so forth. A “pillar” can refer to any support structure that supports a tool against another item, such as another tool. A “dimple” can refer to an indentation on a surface of a tool, and a “protrusion” can refer to a raised portion on a surface.

As used here, “repeating structures” can refer to structures on a tool (e.g., a mold tool) to be used during a manufacture (e.g., as part of a molded fiber manufacturing process) of a part. The repeating structures are repeatedly placed at multiple locations on a tool. As an example, a pore of a given size or shape can be repeated across multiple locations on a tool. The repeating structures can be arranged in a grid or in another pattern.

In some examples, mold tools are hand-made. For example, a screen can be made up of fine metal mesh hammered into place over form tools that are machined metal blocks with holes drilled through them. Pores in other mold tools can be formed by manually drilling the pores. Manually making mold tools can be labor intensive and costly.

In other examples, mold tools can be manufactured using subtractive manufacturing techniques, in which various features (including repeating structures) of the mold tools are formed by cutting away portions of a block of material. Manual subtractive manufacturing techniques may not reliably form small dimension repeating structures on mold tools, and may also be associated with relatively high manufacturing costs.

In accordance with some implementations, techniques or mechanisms are provided to build tools (such as mold tools used in molded fiber manufacturing processes) using additive manufacturing machines. As used here, a “tool” is a component that is used to build a physical part.

In some examples, techniques or mechanisms are provided to automate the design of tools to generate digital representations of the tools that are to be used by additive manufacturing machines in building the tools. In some examples, digital representations of the tools can be in the form of computer-aided design (CAD) files that can be provided to additive manufacturing machines to build the tools described in the CAD files. In other examples, other types of digital representations of tools can be used.

Additive manufacturing machines produce three-dimensional (3D) objects by accumulating layers of build material, including a layer-by-layer accumulation and solidification of the build material patterned from digital representations of physical 3D objects to be formed. A type of an additive manufacturing machine is referred to as a 3D printing system. Each layer of the build material is patterned into a corresponding part (or parts) of the 3D object, based on application of a liquid agent to selected portions of the layer, followed by a further processing (e.g., heating) of the layer after the liquid agent is applied.

Building tools using additive manufacturing processes allows for better control of properties of structures, including repeating structures, on the tools, as compared to traditional manufacturing techniques. Also, building tools using additive manufacturing processes can be associated with faster turnaround times and lower manufacturing costs as compared to traditional manufacturing techniques.

Automated techniques or mechanisms for designing tools to be built by additive manufacturing processes can consider a variety of information relating to a tool to be built when setting properties of repeating structures of the tool. For example, the properties of the repeating structures can include sizes and/or shapes of pores, dimensions of pillars that support screens or other tools, and so forth. The foregoing are examples of physical properties of repeating structures of tools.

In some examples, properties of repeating structures can be determined based on which regions of a tool are associated with higher liquid flow than other regions of the tool. Pores in a region associated with a potentially higher liquid flow can be designed to be smaller, or alternatively, can be arranged to have a lower density of pores. An example of a region of a tool with a potentially increased liquid flow is a region where inclined surfaces or other features tend to focus liquid flow to the region.

As another example, pillars may be used to support a screen on a form. A “form” is a tool that has a general shape of the screen and is used to support the screen during a molded fiber manufacturing process. In the molded fiber manufacturing process, an assembly of the screen placed on the form can be dipped into a fibrous slurry including cellulose fibers suspended in a liquid. A suction device pulls the fibers onto the screen, and the liquid of the fibrous slurry flows through the pores of the screen and pores in the form into a plenum. A part to be built using the molded fiber manufacturing process takes the general shape of the screen. A transfer tool can then be used to transfer the part on the screen away from the screen, and the transfer tool can move the part to another location for drying. The transfer tool may also include pores and/or other repeating structures.

In further examples, there may be certain regions of a screen where it may be desired to control lateral liquid flow between pillars that support the screen on a form. “Lateral liquid flow” can refer to flow that occurs in a direction between the screen and the form in a direction that is generally perpendicular to a direction of liquid flow into a pore of the screen. To reduce lateral liquid flow, the pillars may be made larger (e.g., larger diameter), or a denser arrangement of pillars may be provided on the screen. To increase lateral liquid flow, the pillars may be made smaller, or a sparser arrangement of pillars may be provided on the screen.

As a further example, where powdered build material is used by an additive manufacturing machine to build a tool, it may be difficult to clean residue powder (left over from the build process of the additive manufacturing machine) from the tool in certain regions of the tool. Pores in such regions may be made larger to make it easier to remove residue powder from the regions.

As yet another example, even though a digital representation of a tool may specify that repeating structures be formed of the same size, the physical repeating structures as formed by an additive manufacturing machine on the tool may vary in size. This may occur if the orientations of build surfaces vary across the tool. For example, forming a pore on a sharply inclined surface of the tool may result in the pore deviating from a target size. To account for this, automated techniques or mechanisms can adjust the digital representation of the tool to specify different sizes of pores for different areas of the tool, to allow the pores when actually built by the additive manufacturing machine to have the same target size. Pores of a “same target size” if the sizes of the pores are within a specified percentage of one another (e.g., within 1%, within 2%, within 5%, within 10%, etc.).

Control of properties of repeating structures of tools to be built by additive manufacturing processes can also consider other factors, in addition to or instead of the factors noted above.

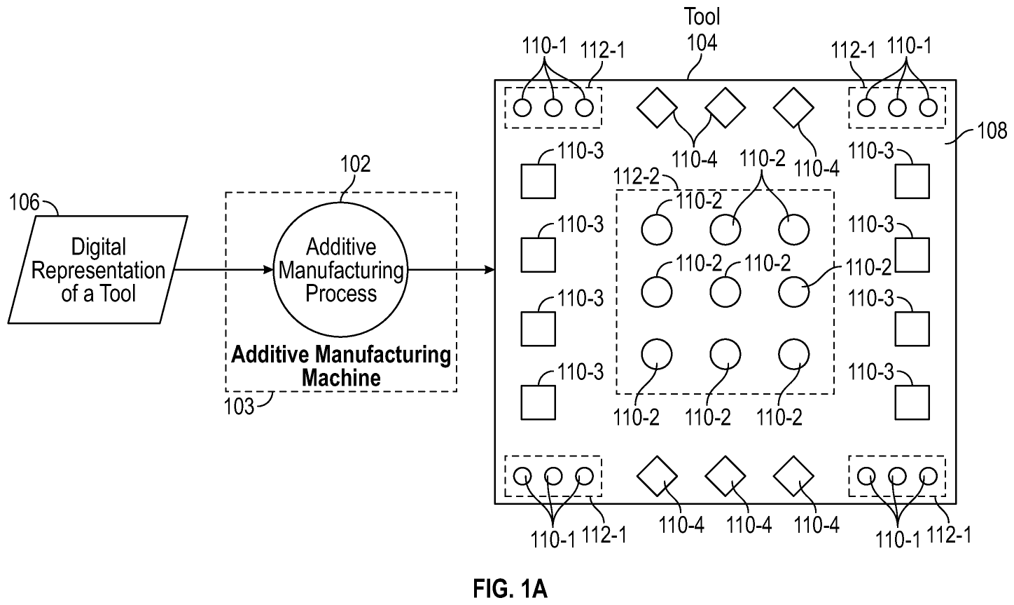

FIG. 1A is a block diagram illustrating use of an additive manufacturing process 102 in building a tool 104. The additive manufacturing process 102 is implemented using an additive manufacturing machine 103.

A digital representation 106 (e.g., a CAD file) of the tool is provided as an input to the additive manufacturing process 102, which builds the tool 104 on a layer-by-layer basis. In the additive manufacturing process 102, a first layer of build material (e.g., powdered build material such as powdered polymer, powdered metal, etc.) is deposited onto a build bed of an additive manufacturing machine, and the layer of build material is then processed (a liquid agent applied, heat applied, etc.) according to a slice of the digital representation 106, where the slice corresponds to the layer of build material. Once the layer of build material has been processed, a subsequent layer of build material is formed on the previously processed layer of build material, and the subsequent layer of build material is processed using another slice of the digital representation 106. The foregoing is repeated until the tool 104 is built according to the digital representation 106.

The tool 104 includes a body 108. In some examples, the tool 104 of FIG. 1A is a screen used in a molded fiber manufacturing process. In other examples, the tool 104 includes a form, a transfer tool, and so forth.

The body 108 of the tool 104 includes repeating structures in the form of pores. In the example of FIG. 1A, the pores are of various different sizes and shapes.

The pores in the body 108 include generally circular pores 110-1 and 110-2. The pores 110-2 have a larger size (e.g., larger diameter) than the pores 110-1. In some examples, the smaller pores 110-1 are located in corner regions 112-1 of the body 108 of the tool 104, while the larger pores 110-2 are located in generally a central region 112-2 of the body 108 of the tool 104.

In some examples, greater liquid flow may potentially be present in the corner regions 112-1 as compared to the central region 112-2. If the tool 104 is used in a molded fiber manufacturing process, then the liquid flow can include a flow of a liquid (e.g., water) of a fibrous slurry that includes cellulose fibers supported in the liquid. The liquid of the fibrous slurry is allowed to pass through the various pores shown in FIG. 1A.

The potentially greater liquid flow in the corner regions 112-1 may be due to the presence of other features (e.g., of another tool) adjacent the tool 104 during a molded fiber manufacturing process. The adjacent features may focus liquid flow towards the corner regions 112-1, which results in a greater potential liquid flow rate in the corner regions 112-1 as compared to the central region 112-2, unless countermeasures are employed. To counter the potentially greater liquid flow rate in the corner regions 112-1, the pores 110-1 can be made to have a smaller size as compared to the pores 110-2. The smaller size of the pores 110-1 effectively reduces liquid flow rate through the pores 110-1 to allow the effective liquid flow rate through the pores 110-1 and 110-2 to be approximately the same.

In other examples, other regions of a tool may have potentially greater liquid flow rates.

In examples according to FIG. 1A, pores 110-3 have rectangular shapes, and pores 110-4 have diamond shapes. In other examples, the pores 110-1 and/or the pores 110-2 can have an elliptical shape. Pores of different shapes may be used for different reasons, such as to fit pores into a small area to avoid the pores overlapping, or to fit a larger quantity of pores in an edge region to allow for as much fluid flow as possible, or for any other reason.

In other examples, pores of different shapes are not used on the body 108 of the tool 104. Rather, pores of just one shape, such as a circular shape, can be used. For example, the pores on the body 108 of the tool 104 can have a circular shape such as the pores 110-1 and 110-2, and the rectangular pores 112-3 and diamond-shaped pores 112-4 are not used.

Note that the pores 110-1, 110-2, 110-3, and 110-4 of different shapes can also have different sizes relative to one another.

More generally, a tool for manufacturing parts (such as the tool 104 of FIG. 1A) includes a body formed using an additive manufacturing process, where the body includes a plurality of repeating structures, and where the plurality of repeating structures include a first subset of repeating structures each having a first physical property as specified by a digital representation (e.g., 106 in FIG. 1A) of the tool used in the additive manufacturing process, and a second subset of repeating structures each having a different second physical property as specified by the digital representation of the tool used in the additive manufacturing process.

FIG. 1B is a perspective view of a portion of a screen 150 including pores of different sizes, according to some examples. The screen 150 includes a first screen surface 152 inclined with respect to a second screen surface 154. For example, the first screen surface 152 may be parallel to or have a relatively small incline with respect to a build bed of the additive manufacturing machine 103, and the second screen surface 154 may have a larger incline with respect to the build bed than the first screen surface 152. A “build bed” can refer to a surface of a build platform of the additive manufacturing machine, or alternatively, to previously processed layer(s) of build material. In the example of FIG. 1B, the first screen surface 152 has pores 156 of a first size (e.g., first diameter), and the second screen surface 154 has pores 158 of a second size (e.g., second diameter) larger than the first size. In other examples, the pores 156 may have a smaller size than the pores 158.

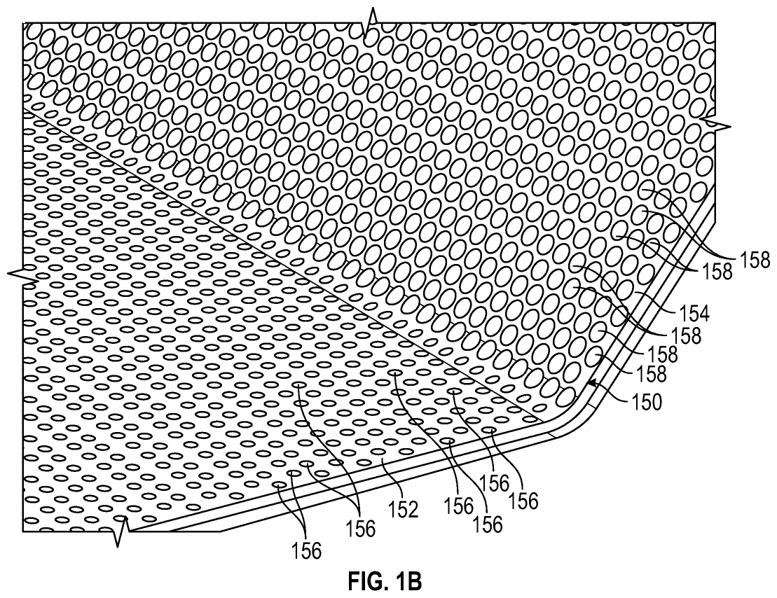

FIG. 2 is a cross-sectional view of a screen 202 mounted over a form 204. The screen 202 has a shape to generally define a shape of a part to be formed by a molded fiber manufacturing process using the screen 202 and the form 204.

The screen 202 includes a first collection of pores 206-1 of a first size, and a second collection of pores 206-2 of a second size that is greater than the first size. If the pores 206-1 and 206-2 are circular pores, then the first size is a first diameter of each pore 206-1, and the second size is a second diameter of each pore 206-2.

Each pore 206-1 or 206-2 extends through a thickness T1 of a body 208 of the screen 202. The pores 206-1 and 206-2 allow for a liquid (e.g., the liquid of a fibrous slurry) to flow through the pores, as indicated by arrows 210. A layer of fibers of the fibrous slurry is left on an upper surface 213 of the screen 202 after the liquid is suctioned through the pores 206-1, 206-2 of the screen 202.

Pillars 212-1 and 212-2 are used to provide support for the screen 202 on the form 204. The pillars 212-1, 212-2 can be part of the screen 202 or part of the form 204. In some examples, the pillars 212-1, 212-2 define a separation in the form of a space 214 between the screen 202 and the form 204.

In some examples, the pillars 212-1 can have a first size, and the pillars 212-2 can have a second size larger than the first size. In some examples, each pillar 212-1, 212-2 is cylindrical in shape. The different sizes of the pillars 212-1 and 212-2 can include different diameters of the cylindrical pillars. In other examples, the pillars are of a shape different from a cylindrical shape. In further examples, different sizes of pillars can refer to different lengths of pillars. For example, the pillars 212-1 can have a first length while the pillars 212-2 can have a second length different from the first length.

In some examples, the size (or other physical property) of the pillars 212-1 may correspond to the size (or other physical property) of the pores 206-1, and the size (or other physical property) of the pillars 212-2 may correspond to the size (or other physical property) of the pores 206-2.

In further examples, the sizes (or other physical properties) of the pillars 212-1, 212-2 can be based on another factor, such as lateral liquid flow. A liquid can flow laterally in gaps between successive pillars 212-1, 212-2. For example, a lateral liquid flow can be present through a gap 216-1 defined between smaller pillars 212-1. The lateral liquid flow through the gap 216-1 is generally perpendicular to a direction of liquid flow through a pore 206-2. As another example, a lateral liquid flow can be present in another gap 216-2 defined between larger pillars 212-2. The gap 216-2 is smaller than the gap 216-1.

In some cases, different regions of the space 214 can be associated with different lateral liquid flow rates due to geometries of the screen 202 and/or the form 204, as well as geometries of other features that may be in the proximity of the screen 202 and the form 204. For example, features may direct liquid to flow from a first number of locations (e.g., liquid flow channels) into the gap 216-2, while liquid flowing into the other gap 216-1 is from a smaller number of locations (e.g., liquid flow channels). As a result, the liquid flow rate into the gap 216-2 can be larger than the liquid flow rate into the gap 216-1, unless a countermeasure is employed.

To counter the differences in potential lateral liquid flow rates in the gaps 216-1 and 216-2, the sizes (e.g., diameters) of the pillars 212-1 and 212-2 can be made to be different. The smaller sized pillars 212-1 can define larger gaps (e.g., 216-1) between successive pillars 212-1, while the larger sized pillars 212-2 can define smaller gaps (e.g., 216-2) between successive pillars 212-2.

Reducing the size of a gap between pillars effectively provides less space for liquid to flow, which can counter potentially larger lateral liquid flow rates in certain in the space 214.

As further shown in FIG. 2, the form 204 has a body 220 that also includes a first collection of pores 222-1 of a first size (e.g., first diameter), and a second collection of pores 222-2 of a second size (e.g., second diameter) larger than the first size.

Liquid flowing into the pores 206-1, 206-2 and through the space 214 can flow through the respective pores 222-1, 222-2 to exit a lower side 224 of the form 204. Although not shown, a suction device can be provided below the lower side 224 of the form 204 to draw the liquid from a fibrous slurry through the pores 206-1, 206-2, the space 214, and the pores 222-1, 222-2.

In addition to controlling liquid flow rates through pores of the screen 202 and the form 204, adjusting pore sizes in the screen 202 and/or the form 204 can also control a thickness of a layer of fiber that is formed on the upper surface 213 of the screen 202. Increasing pore sizes can allow for a larger liquid flow rate, and thus a greater quantity of the liquid of a fibrous slurry can be drawn through the screen 202 and form 204 per unit time. Drawing a greater quantity of the liquid of the fibrous slurry through the screen 202 and form 204 can allow a larger thickness of fiber to be formed on the upper surface 213 of the screen 202.

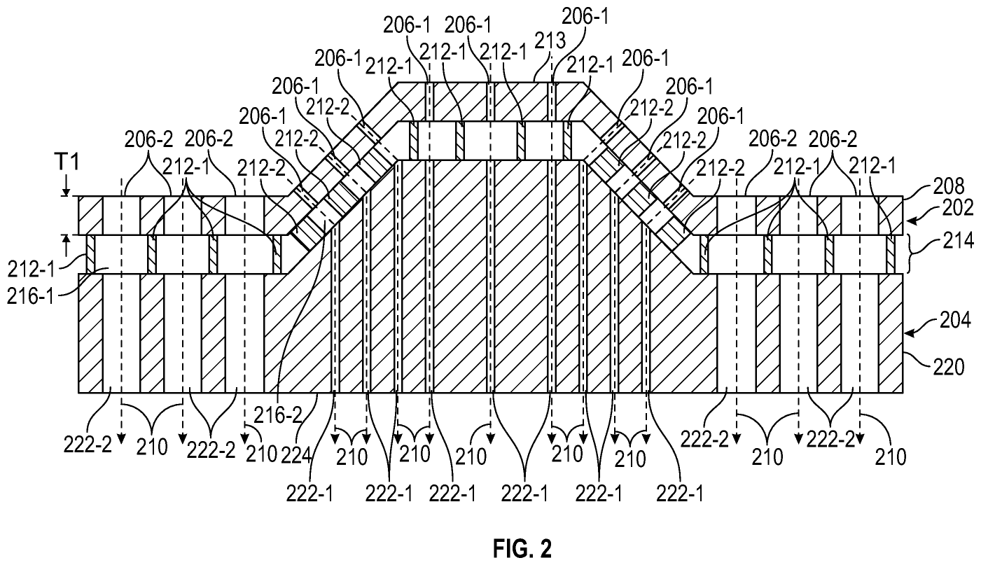

FIG. 3 is a flow diagram of an automated process 300 of providing a digital representation of a tool, where the digital representation is to be used by an additive manufacturing machine to build the tool according to the digital representation. The process 300 can be performed by a computer system, which can include a computer or multiple computers.

The process 300 includes receiving (at 302) information relating to the tool useable for manufacturing parts. The received information can include any or some combination of the following, as examples: liquid flow rate information for region(s) of the tool (e.g., information identifying a given region as a region of potentially high liquid flow rate, information specifying a liquid flow rate range through a given region, etc.), an orientation of a surface on which a repeating structure is to be formed (where the orientation can be measured relative to an additive manufacturing machine build bed surface, for example), information indicating that a given region of the tool is associated with an increased difficulty in cleaning residue build material powder (left over from an additive manufacturing process used to build the tool), information indicating that a given region of the tool is associated with a deviation in a physical property of a repeating structure when formed in the given region (e.g., a pore of the tool may be formed to be smaller or larger than a target size because the pore is in a highly inclined surface of the tool), information indicating a presence of an obstruction or other mass that may impact a liquid flow, and so forth.

Based on the received information, the process 300 determines (at 304) physical properties of a plurality of repeating structures of the tool, where the determining includes specifying a first physical property for a first subset of the plurality of repeating structures, and specifying a different second physical property for a second subset of the plurality of repeating structures.

For example, if the received information indicates that a liquid flow rate through a given region of the tool is potentially larger than another region of the tool, then the process 300 can set pores in the given region to have smaller sizes to counter the potentially larger liquid flow rate through pores in the given region.

As a further example, the received information can specify an angle of a surface of the tool relative to a plane of a build bed in an additive manufacturing machine. The surface of the tool is the surface in or on which a pore or other repeating structure is to be formed. An orientation of the surface of the tool refers to the angle of this surface relative to the plane of the build bed (which can be horizontal or which can be inclined). The process 300 can compute a size of a repeating structure (e.g., a pore) based on the determined orientation of the surface.

As another example, if the received information indicates that a lateral liquid flow rate between pillars in a given region of the tool is potentially larger than another region of the tool, then the process 300 can set the pillars in the given region to have a larger size to reduce the size of gaps between successive pillars in the given region, to counter the potentially larger lateral liquid flow rate in the given region.

As a further example, if the received information indicates that a given region of the tool is associated with an increased difficulty in cleaning residue build material powder, then the process 300 can set pores in the given region of the tool to be larger to allow the residue build material powder to more readily pass through the pores when cleaning the tool after being built by an additive manufacturing process. More generally, the process 300 sets a physical property of a repeating structure based on a factor relating to cleaning residue powdered build material, where the factor can include ease of cleaning the residue powdered build material, an amount of residue powdered build material expected to be present, and so forth.

As yet another example, if the received information indicates that a given region of the tool is associated with a deviation in a physical property (from a target physical property) of a repeating structure when formed in the given region (e.g., a pore of the tool may be formed to be smaller or larger than a target size because the pore is in a highly inclined surface of the tool), then the process 300 can adjust the physical property to deviate from the target physical property in the digital representation to be created by the process 300. For example, pores in a first region of the tool and a second region of the tool are supposed to have the same target size. However, the first region of the tool may have a highly inclined surface that may cause a pore formed in the first region to deviate from the target size when built by an additive manufacturing process even though a digital representation of the tool specifies that the pore is to have the target size. To counter this effect, the process 300 can set pores in the first region to have a different size (different from the target size), and can set pores in the second region to have the target size, such that when the tool is built by an additive manufacturing process, the pores in the first region and the pores in the second region as built by the additive manufacturing process will have approximately the same size (e.g., within 1% of one another, or within 2% of one another, or within 5% of one another, or within 10% of one another, etc.).

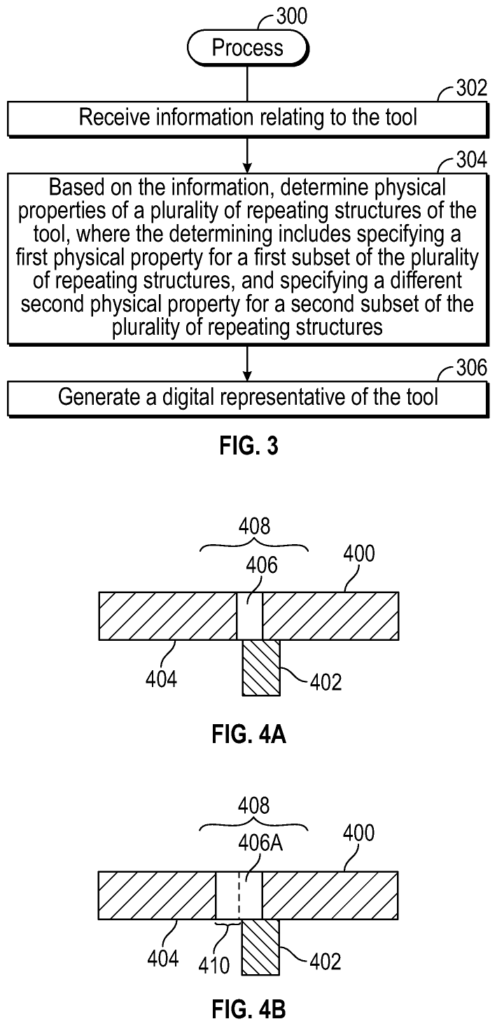

As yet a further example, if the received information indicates a presence of an obstruction or other mass in a given region that may impact a liquid flow, then the process 300 can adjust a physical property (e.g., a size) of repeating structures in the given region to account for the presence of the obstruction or other mass. For example, as shown in FIG. 4A, a pillar 402 depending from a lower surface 404 of a screen 400 may partially obstruct a pore 406 in a given region 408 of the screen 400. To account for this obstruction or other mass of the pore 406 (which may reduce a liquid flow rate through the pore 406), the process 300 can increase a size of a pore 406A so that an effective liquid flow rate area of the pore 406A matches a target liquid flow rate area. For example, the process 300 can increase a diameter of the pore 406A by an amount 410 relative to the pore 406 of FIG. 4A, to counter the liquid flow obstruction or other mass presented by the pillar 402. More generally, a physical property of a pore or another repeating structure of a tool may be adjusted based on presence of a mass in a proximity of the repeating structure.

The process 300 generates (at 306) the digital representation of the tool, the digital representation including information specifying the first physical property for the first subset of the plurality of repeating structures, and specifying the second physical property for the second subset of the plurality of repeating structures.

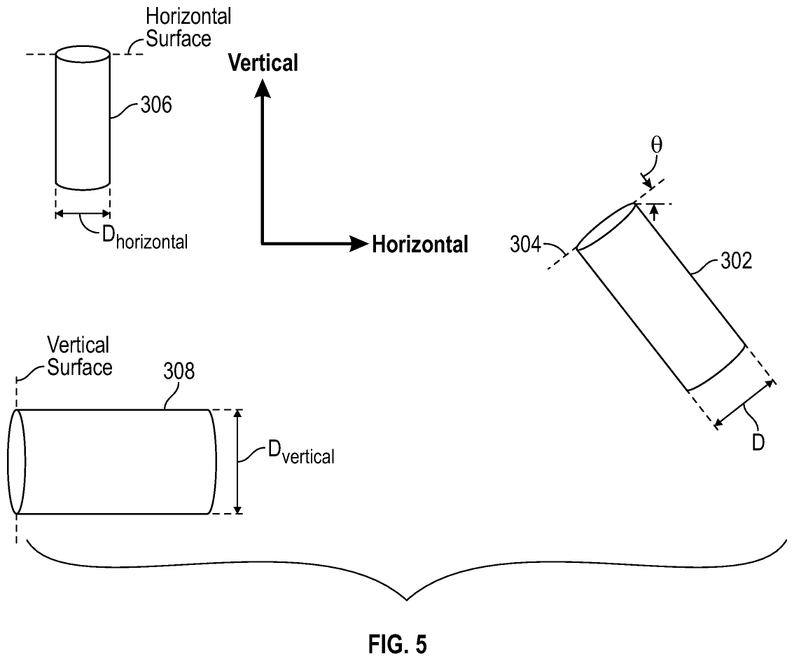

FIG. 5 shows an example of determining a size (e.g., a diameter D) of a pore 302, which can extend through a screen, a form, or any other type of tool. The pore 302 is depicted as having a cylindrical shape and is defined within a body of a tool.

In some examples, the diameter D of the pore 302 is based on an orientation of the pore 302 with respect to a horizontal axis and a vertical axis. The pore 302 is formed in a surface 304 that is inclined with respect to each of the horizontal axis and the vertical axis.

In some examples, a parameter D_{vertical} and a parameter D_{horizontal} are defined. The parameter D_{vertical} represents a diameter of a pore 308 that is formed in a vertical surface along the vertical axis. The parameter D_{horizontal} represents a diameter of a pore 306 that is formed in a horizontal surface along the horizontal axis.

In some examples, the parameter D_{vertical} and the parameter D_{horizontal} are preset values, which can be set by a user or another entity (a program or a machine). In examples according to FIG. 5, the value of D_{horizontal} is smaller than the value of D_{vertical}. Thus, in examples according to FIG. 5, a pore (e.g., 306) formed in the horizontal surface has a smaller diameter than a pore (e.g., 308) formed in the vertical surface, to account for likelihood of greater liquid flow through the pore 306 than through the pore 308.

For the pore 302 that is inclined with respect to both the vertical axis and the horizontal axis, a diameter D(θ) of the pore 302 is a modulated value derived from D_{horizontal} and another parameter D_{additional}, such as according to the equation below:

D(θ)=D_{horizontal}+sin(θ)·D_{additional}.

In the above equation, θ represents the angle of the surface 304 in which the pore 302 is formed, such as relative to a horizontal surface. Thus, θ can range between 0 (if the pore 302 is formed in the horizontal surface) and π/2 (if the pore 302 is formed in the vertical surface).

Note that D_{vertical}=D_{horizontal}+D_{additional}, since sin(π/2) is equal to 1. Thus, if D_{vertical} and D_{horizontal} are preset values, then D_{additional} can be derived from the relationship above.

In other examples, other equations for determining the diameter D of the pore 302 can be used.

In some examples, it can be assumed that the horizontal axis is in a plane of a build bed in an additive manufacturing machine. In examples where the build bed has a surface that is not in a horizontal plane, then the “horizontal” axis can refer to an inclined axis.

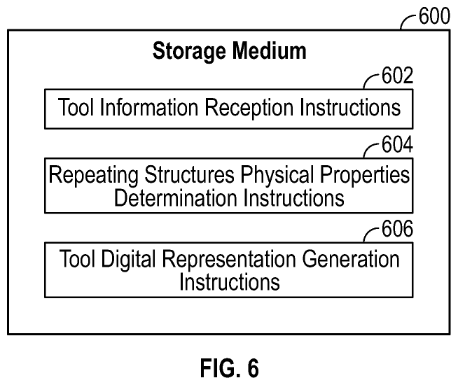

FIG. 6 is a block diagram of a non-transitory machine-readable or computer-readable storage medium 600 storing machine-readable instructions that upon execution cause a system to perform various tasks. The system can include a computer or multiple computers.

The machine-readable instructions include tool information reception instructions 602 to receive information relating to a tool useable for manufacturing parts.

The machine-readable instructions include repeating structures physical properties determination instructions 604 to, based on the information that is indicative of an interaction of a material with the tool (e.g., liquid flow rate in a region of the tool, residue powdered build material removal from the tool, etc.), determine physical properties of a plurality of repeating structures of the tool, where the determining includes specifying a first physical property for a first subset of the plurality of repeating structures, and specifying a different second physical property for a second subset of the plurality of repeating structures.

The machine-readable instructions include tool digital representation generation instructions 606 to generate a digital representation of the tool, the digital representation including information specifying the first physical property for the first subset of the plurality of repeating structures, and specifying the second physical property for the second subset of the plurality of repeating structures.

In some examples, machine-readable instructions can detect different orientations of a first surface and a second surface of the tool. The machine-readable instructions can specify a first size of a first repeating structure on the first surface, and specify a different second size of a second repeating structure on the second surface. The machine-readable instructions includes, in the digital representation, information specifying the first size of the first repeating structure and information specifying the second size of the second repeating structure, where the first repeating structure and the second repeating structure when built by an additive manufacturing machine have substantially a same size (e.g., sizes within 1% of one another, or sizes within 2% of one another, or sizes within 5% of one another, or sizes within 10% of one another, etc.).

A hardware processor that can execute the machine-readable instructions can include a microprocessor, a core of a multi-core microprocessor, a microcontroller, a programmable integrated circuit, a programmable gate array, or another hardware processing circuit.

The storage medium 600 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory or other type of non-volatile memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A tool for manufacturing parts, comprising:
a body formed using an additive manufacturing process, the body comprising a plurality of repeating structures, wherein the plurality of repeating structures comprise a first subset of repeating structures each having a first physical property as specified by a digital representation of the tool used in the additive manufacturing process, and a second subset of repeating structures each having a different second physical property as specified by the digital representation of the tool used in the additive manufacturing process.

2. The tool of claim 1, wherein the first physical property comprises a first size, and the second physical property comprises a second size different from the first size.

3. The tool of claim 1, wherein the first physical property comprises a first shape, and the second physical property comprises a second shape different from the first shape.

4. The tool of claim 1, wherein the plurality of repeating structures comprise pores through which a liquid is to pass to manufacture a part using the tool.

5. The tool of claim 4, wherein the first subset of repeating structures comprises a first subset of pores of a first size, and the second subset of repeating structures comprises a second subset of pores of a different second size.

6. The tool of claim 1, wherein the plurality of repeating structures comprise pillars to support the tool on another tool

7. The tool of claim 1, wherein the plurality of repeating structures comprise dimples or protrusions on a surface of the tool.

8. The tool of claim 1, wherein the tool comprises a screen with pores.

9. The tool of claim 1, wherein the tool comprises a form for a molded fiber manufacturing process.

10. A method of a system comprising a hardware processor, comprising:
receiving information relating to a tool useable for manufacturing parts;
based on the information, determining physical properties of a plurality of repeating structures of the tool, wherein the determining comprises specifying a first physical property for a first subset of the plurality of repeating structures, and specifying a different second physical property for a second subset of the plurality of repeating structures; and
generating a digital representation of the tool, the digital representation including information specifying the first physical property for the first subset of the plurality of repeating structures, and specifying the second physical property for the second subset of the plurality of repeating structures.

11. The method of claim 10, wherein the determining of the physical properties of the plurality of repeating structures is based on orientations of respective repeating structures of the plurality of repeating structures on a build surface of the tool or based on presence of masses proximate repeating structures of the plurality of repeating structures.

12. The method of claim 10, wherein the determining of the physical properties of the plurality of repeating structures is based on liquid flow rates of respective regions of the tool.

13. The method of claim 10, wherein the determining of the physical properties of the plurality of repeating structures is based on a factor relating to cleaning residue powdered build material.

14. A non-transitory machine-readable storage medium comprising instructions that upon execution cause a system to:
receive information relating to a tool useable for manufacturing parts;
based on the information that is indicative of an interaction of a material with the tool, determine physical properties of a plurality of repeating structures of the tool, wherein the determining comprises specifying a first physical property for a first subset of the plurality of repeating structures, and specifying a different second physical property for a second subset of the plurality of repeating structures; and
generate a digital representation of the tool, the digital representation including information specifying the first physical property for the first subset of the plurality of repeating structures, and specifying the second physical property for the second subset of the plurality of repeating structures.

15. The non-transitory machine-readable storage medium of claim 14, wherein the instructions upon execution cause the system to:
detect different orientations of a first surface and a second surface of the tool;
specify a first size of a first repeating structure on the first surface;
specify a second size of a second repeating structure on the second surface; and
include, in the digital representation, information specifying the first size of the first repeating structure and information specifying the second size of the second repeating structure, wherein the first repeating structure and the second repeating structure when built by an additive manufacturing machine have substantially a same size.
